(19) United States
(12) Patent Application Publication
(10) Pub. No.: US 2004/0207568 A1
(43) Pub. Date: Oct. 21, 2004

(54) Portable information processing apparatus and method for displaying image

(75) Inventors: Tetsuya Ooshima, Tokyo (JP); Shoichi Hirota, Hitachi (JP); Hiroki Kaneko, Hitachi (JP); Susumu Edo, Mito (JP); Yoshifumi Sekiguchi, Hitachi (JP); Tatsuya Sugita, Takahagi (JP); Shinichi Komura, Hitachi (JP); Masahiro Kawasaki, Tsukuba (JP)

Correspondence Address: HOGAN & HARTSON L.L.P., 500 S. GRAND AVENUE, SUITE 1900, LOS ANGELES, CA, 90071-2611, US

(73) Assignee: HITACHI, LTD.

(21) Appl. No.: 10/809,100

(22) Filed: Mar. 25, 2004

(30) Foreign Application Priority Data
Mar. 31, 2003 (JP) 2003-095476

(51) Int. Cl. G09G 5/00

(52) U.S. Cl. 345/1.1

(57) ABSTRACT

In a portable information processing apparatus, frames 5 and 6 on which display devices are mounted are pivotally supported in a coupling portion 3 constituted by a hinge mechanism in an openable/closable manner, while the display devices have main displays 1 and 2, which perform printing with high-resolution quality. While the coupling portion 3 is set to a fulcrum, the main displays 1 and 2 are brought into such a two-page spreading condition for the use, and are overlapped with each other, and are folded into two displays for closure, so that the portable information processing apparatus can be carried. Since a rotation portion 4 is rotated, an image which is displayed on the main displays 1 and 2 can be changed. Both a power switch 7 and a function switch 8, which are necessary switches and the like, are mounted on an edge portion of the frame 6.

### BACKGROUND OF THE INVENTION

The present invention is related to a portable information processing apparatus, and a method for displaying an image in this portable information processing apparatus.

The book-type dual screen display apparatus has been proposed which can also have portability corresponding to characteristics owned by books, while qualities of image information obtained from printed matters such as books and the like are not deteriorated (refer to JP-A-9-26769, paragraphs [0029] to [0036], and FIG. 2 to FIG. 4). Also, in order to easily observe contents of paperback-sized electronic books while improving display qualities, a two-page spreadable display apparatus for electronic books has been proposed which is constructed of two liquid display (LCD) panels, and in which either a pixel or a pixel pitch is made smaller than, or equal to 200 μm (refer to JP-A-6-138839, paragraphs [0006] to [0009], FIG. 1).

### SUMMARY OF THE INVENTION

The present invention has been made to solve the above-described problems, and has an object to both a portable information processing apparatus and a method for displaying an image, capable of improving operations and handling qualities by employing a display device capable of performing a printing type quality high-resolution imaging operation, and further by arranging components, while paying an attention to human engineering.

In any of the above-described conventional techniques, LCDs are employed as display devices, and thus, the conventional display apparatus cannot play a role as functions of books in view of resolution aspects. This is because a limitation as to display qualities may be revealed in presently-available LCD techniques.

Also, the conventional portable information processing apparatus are not equipped with such user interfaces which have been designed by considering portability originally owned by portable information processing apparatus. Thus, the conventional portable information processing apparatus own difficulties as to operations and handling characteristics.

To solve the above-described problems, the present invention can provide both a portable information processing apparatus and an image displaying method, capable of improving operations and handling characteristics by such a manner that while a device for performing a printing type quality high resolution imaging operation (for example, e-paper using electrophoretic display) is employed as a display device, electronic books stored in card media, Web (World Wide Web) screens, newspapers and catalogs which are acquired through wireless interfaces are displayed on this display device, and further, components such as switches are arranged by paying an attention to the human engineering.

It is so assumed that description contents based upon pixel sizes of displays in claims are described in accordance with resolution of the display surfaces in embodiment modes of the present invention. A relationship between pixel sizes and resolution is described as follows:

pixel size being smaller than, or equal to 127.0 μm→resolution being higher than, or equal to 200 ppi

pixel size being smaller than, or equal to 84.7 μm→resolution being higher than, or equal to 300 ppi

pixel size being smaller than, or equal to 42.3 μm→resolution being higher than, or equal to 600 ppi

As previously explained, in accordance with the present invention, such an image information processing apparatus and such a method for displaying an image can be provided, which are capable of improving operations and handling characteristics by employing a display device capable of performing a printing type quality high-resolution imaging operation, and further by arranging components, while paying an attention to human engineering.

Other objects, features and advantages of the present invention may become apparent from the below-mentioned descriptions as to embodiments of the present invention related to accompanying drawings.

### BRIEF DESCRIPTION OF THE DRAWINGS

FIG. 1 is a diagram for indicating a portable information processing apparatus according to a first embodiment mode of the present invention.

FIG. 2 is a diagram for indicating a display exemplification of FIG. 1.

FIG. 3 is a diagram for indicating a display exemplification of FIG. 1.

FIG. 4 is a diagram for indicating a display exemplification of FIG. 1.

FIG. 5 is a diagram for indicating a portable information processing apparatus according to a second embodiment mode of the present invention;

FIG. 6A and FIG. 6B are diagrams for indicating a display exemplifications of FIG. 5.

FIG. 7A and FIG. 7B are diagrams for indicating a display exemplifications of FIG. 5.

FIG. 8 is a diagram for representing a display basic idea of a sheet display according to an embodiment mode of the present invention.

FIG. 9 is a block diagram for showing an internal structure of a portable information processing apparatus according to the embodiment mode of the present invention.

FIG. 10 is a diagram for representing a relationship between subjective evaluation and resolution of printing type quality high-resolution imaging operation according to the embodiment mode of the present invention.

FIG. 11 is a diagram for explaining the resolution of the printing type quality high-resolution imaging operation according to the embodiment mode of the present invention.

### DESCRIPTION OF THE EMBODIMENTS

Referring now to drawings, a description will be made of embodiment modes of the present invention.

### First Embodiment Mode

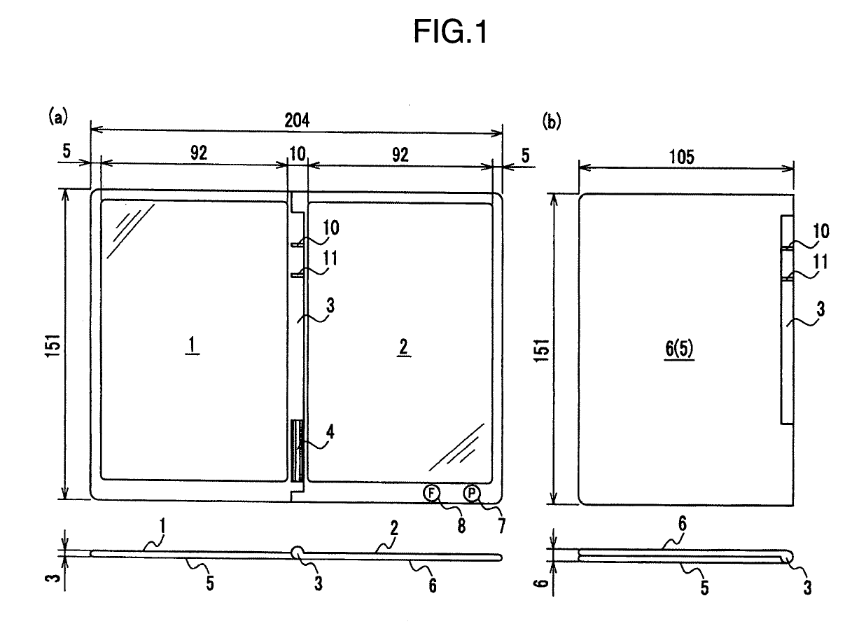

FIG. 1 is a diagram for showing an portable information processing apparatus according to a first embodiment mode of the present invention, and represents a front view and a plan view when a display surface of the portable information processing apparatus is opened and closed, respectively.

In accordance with the portable information processing apparatus shown in FIG. 1, frames 5 and 6 on which a display device is mounted are pivotally supported by a hinge portion 3 in an openable/closable manner. The display device owns display surfaces (will be referred to as “main displays 1 and 2” hereinafter) which perform printing type quality high-resolution imaging operations. The hinge portion 3 is constituted by a hinge mechanism. While the hinge portion 3 is set to a fulcrum and the main displays 1 and 2 are brought into a two-page spread condition, the portable information processing apparatus is used (see FIG. 1(a)). While the hinge portion 3 is set to the fulcrum, and the main displays 1 and 2 are overlapped with each other so as to be folded into two displays and are stored in order to be closed, the portable information processing apparatus can be carried (see FIG. 1(b)). It should be understood that the hinge portion 3 implies such a portion that a left-sided frame 5 is overlapped with a right-sided frame 6, while involving a portion for connecting the left-sided frame 5 to the right-sided frame 6.

As display surfaces which perform printing type quality high-resolution imaging operations, a display surface having resolution higher than, or equal to 200 ppi without a gray scale, another display surface having resolution higher than, or equal to 300 ppi with a gray scale, or, preferably, another display surface having resolution higher than, or equal to 600 ppi may be provided. A definition and a ground about the above-explained display surfaces will be explained later.

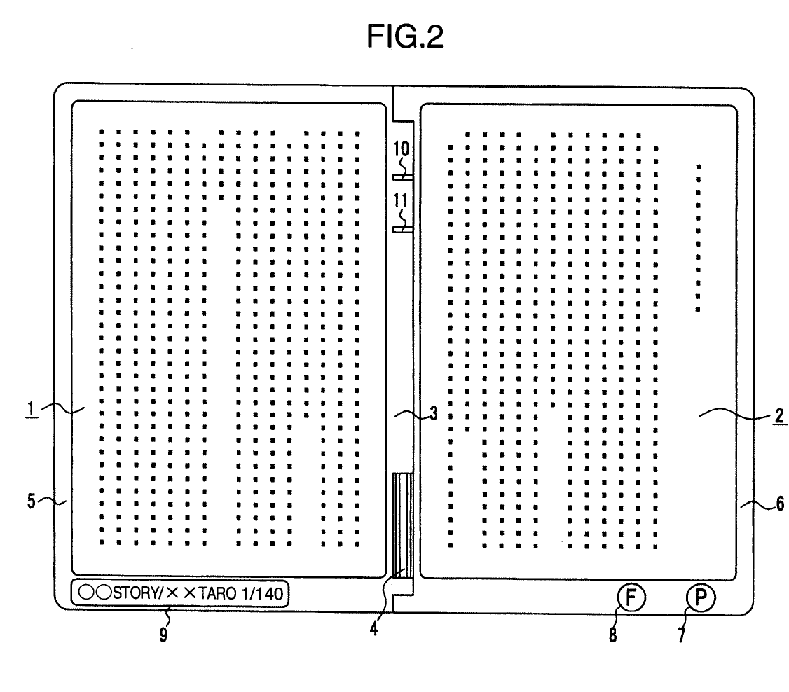

As indicated in FIG. 2, an electronic book is displayed on the main displays 1 and 2 which are brought into a two-page spread condition. A cylinder-shaped rotation portion 4 whose shorter sides are located at the top thereof and which are rotated along a lateral direction is mounted on a lower center portion of the hinge portion 3 along a longitudinal direction, and since an operation of the rotation portion 4 is defined in relation to a page-turning-over operation, the page-turning-over operation is carried out. It should be noted that the rotation portion 4 corresponds to, for instance, a jogdial (R), or the like.

Mechanical displacements obtained by manipulating the rotation portion 4 are basically made of such elements as rotations along two directions (right/left directions), displacement along two directions (upper/lower directions), and displacement by pushing the rotor. Among others, rotation amounts along respective directions, and rotation speeds along respective rotation directions may be obtained by calculations based open the rotation amounts thereof. As a result, since the changes obtained in connection with manipulations of the rotation portion 4 are defined in relation to the page-turning-over operation, handling qualities may be improved.

As a consequence, a user can manipulate the rotation portion 4 along the lateral direction, which is the same feeling when the user turns over the pages of a book. Also, the rotation portion 4 is made of such a construction whose shorter edges are located at the top thereof, which can be easily manipulated when the user holds the portable information processing apparatus by one hand of this user. Further, since vertical lines for a non-slip purpose are formed in this rotation portion 4, operation of this rotation portion 4 can be improved. In addition, since the rotation portion 4 is rotated, images displayed on the main displays 1 and 2 can be changed, and there are sufficiently larger chances as to how the rotation portion 4 is manipulated.

Also, while the display device having the main displays 1 and 2 are mounted on the frames 5 and 6, respectively, both a power supply switch 7 and a function switch 8 which correspond to switch and the like required so as to operate this portable information processing apparatus are mounted on an unoccupied position of an edge of one frame 6 where the display device of the main display 2 is mounted. These switch and the like are mounted on such a position that when these switch and the like are operated, visual recognitions as to contents viewed on the main displays 1 and 2 are not disturbed, namely are mounted on a central right position under the screen in FIG. 2.

Furthermore, an outside display 9 is mounted at such a position of the other frame 5 where the switch and the like are not mounted that this mounting position is overlapped with the frame 6 where the switch and the like are mounted under such a condition that the main displays 1 and 2 are overlapped with each other and are stored in two folding states (see FIG. 2). The outside display 9 displays thereon bibliographic information including a title of a book, an editor, and a page number.

FIG. 2 exemplifies such an example that since a right-handed user manipulates the switch and the like by a right hand of this user, the switch and the like are arranged at a lower right position, and the outside display 9 is arranged at a lower left position. Alternatively, such an arrangement may be conceived. That is, as to a left-handed user, the switch and the like are arranged at the lower left position, and the outside display 9 is arranged at the lower right position. As previously explained, since the arrangements as to the switch and the like and the outside display 9 are determined based upon the human engineering aspect, the operation of the portable information processing apparatus may be furthermore improved.

It is so assumed that the switch and the like may be separately turned ON/OFF, and furthermore, a large number of functions may be defined by combining these switch and the like with each other by monitoring time durations during which the switches are pushed. Alternatively, in order to increase a display size, while the main displays 1 and 2 may be mounted on the entire frame and a touch panel may be displayed on a screen edge thereof, a software input by using a display keyboard image may be carried out. In this alternative case, the outside display 9 may be mounted on a front plane of the frame. In addition to the software input by using the display keyboard image, it is conceivable that key input operations may be carried out by wireless (Bluetooth(R), infrared rays, and the like) with employment of a remote controller, a portable telephone, and the like.

On the other hand, both a power indicator 10 and an access indicator 11 are also mounted on the hinge portion 3. The power indicator 10 and the access indicator 11 are constituted by LEDs (Light Emitting Diodes), and display ON/OFF states of a power supply. These indicators 10 and 11 can be visually confirmed from an external area under two-page spread condition, and also, under such a condition that the main displays 1 and 2 are closed in such a manner that the main displays 1 and 2 are overlapped with each other and are folded into two displays so as to be stored.

For instance, with respect to the portable information processing apparatus according to an embodiment mode of the present invention, the frames 5 and 6 are designed in a paperback size of 151 mm×105 mm×6 mm when this portable information processing apparatus is stored, and also, designed in a size of 151 mm×204 mm×3 mm when this portable information processing apparatus is used. In order that the portable information processing apparatus is held by one hand of a user and is operated by the user while the portable information processing apparatus is used, a thickness thereof is selected to be 3 mm in an optimum condition, and a weight thereof is made lighter than 200 g in a favorable condition.

It should be noted that in accordance with the above-described embodiment mode, the electronic books are displayed on the main displays 1 and 2 respectively under the two-page spread condition. Alternatively, an electronic dictionary may be displayed on one of these main displays 1 and 2 by way of a predetermined switching operation, or a software input by using a display keyboard image. Also, in such a case that the electronic book is displayed, it is so assumed that a marking function using the switch and the like and the outside display 9 is added which may be replaced by a tag and a bookmark, and thus, a care is taken so as to provide conveniences to the user.

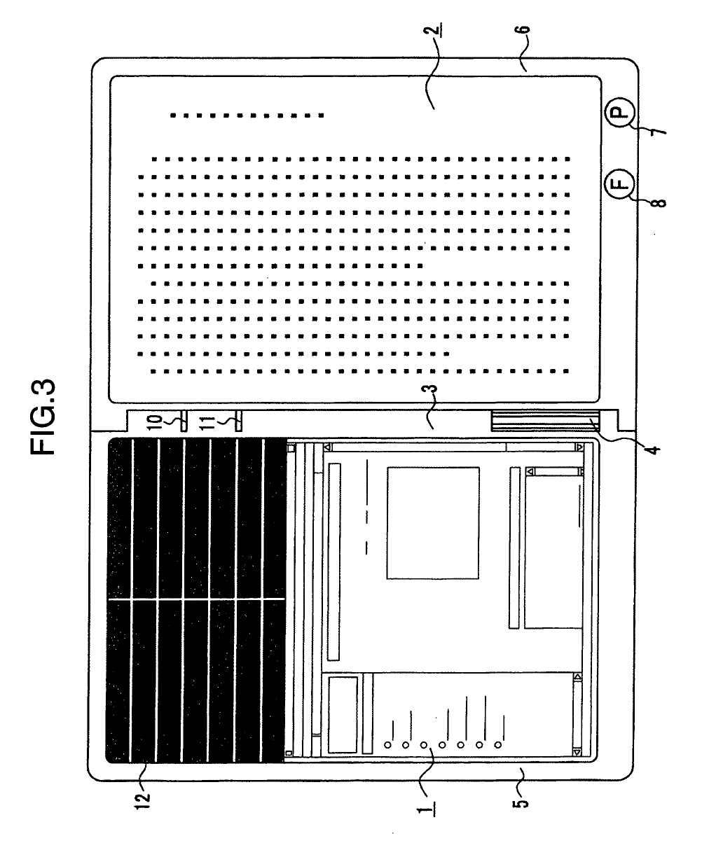

FIG. 3 is another display exemplification. That is, a Web screen is displayed on the main display 1 in the normal resolution, and an electronic book is displayed on the main display 2 in such a printing type quality resolution which is different from that of this Web screen.

In this display exemplification, it is so assumed that the Web screen is displayed in color and in the resolution of 200 ppi (pixel per inch: total pixel number per 1 inch), whereas the electronic book is displayed in the resolution of 600 ppi. In order to display different contents in the different resolution on the main displays 1 and 2 respectively, if both display controllers and display memories are separately employed, then display control operations may be carried out in an easy manner. In this display exemplification, it is so assumed that while a commonly-operable display controller is employed in view of a power saving purpose, a commonly-operable display memory is sectioned so as to be controlled. Also, it is so assumed that an allocation of display data to display surfaces is automatically carried out in response to resolution, while this allocation of the display data is performed in such a manner that the Web screen containing a color image is displayed on the main display 1 and the electronic book corresponding to character information is displayed on the main display 2. It should be understood that in order to furthermore emphasize the power saving operation, the display memory may be alternatively allocated to a main memory, and the function of the display controller may be executed by a CPU. It is so assumed that a detailed explanation as to an internal structure and the like of the portable information processing apparatus will be made later.

Alternatively, a solar cell 12 may be mounted on a portion of the frame 5 on which the display device of the main display 1 where the Web screen is displayed is mounted. In this alternative case, while the solar cell 12 is used as an auxiliary power source, either a lithium ion battery or a polymer battery is used as a main power source.

In the above-described embodiment mode, such an exemplification that the Web screen is displayed on one screen has been shown. Alternatively, two screens (namely, right/left screens) may be allocated as the Web screen. The following exemplifications may be conceived. That is, an exclusively-used site may be displayed on one display screen and a content may be displayed on the other display screen, i.e., a right/left asymmetrical type display. Also, a content which is wanted to viewed may be alternately displayed on the right display screen and the left display screen, i.e., a right/left symmetrical type display. In particular, as to the right/left symmetrical type, such a display variation may be realized in such a manner that while a display screen is subdivided into a right display screen and a left display screen, a continuation of a content which has been displayed on the left screen is displayed on the right display screen. Also, another idea may be alternatively conceived in which two display screens are arranged at upper/lower positions and a display content is scrolled over the upper/lower display screens. It is so assumed that the scrolling operation of the display screens is performed in an inter connection manner-between the two display screens in any of the above-described exemplifications. Also, in the above-described embodiment mode, such an arrangement that there are two main displays has been explained. Alternatively, such an arrangement that 3, or more sets of main displays are provided may be employed. For instance, while two sets of coupling portions constructed of hinge mechanisms are provided so as to couple three sets of main displays to each other, these three main displays may be folded into three displays so as to be stored.

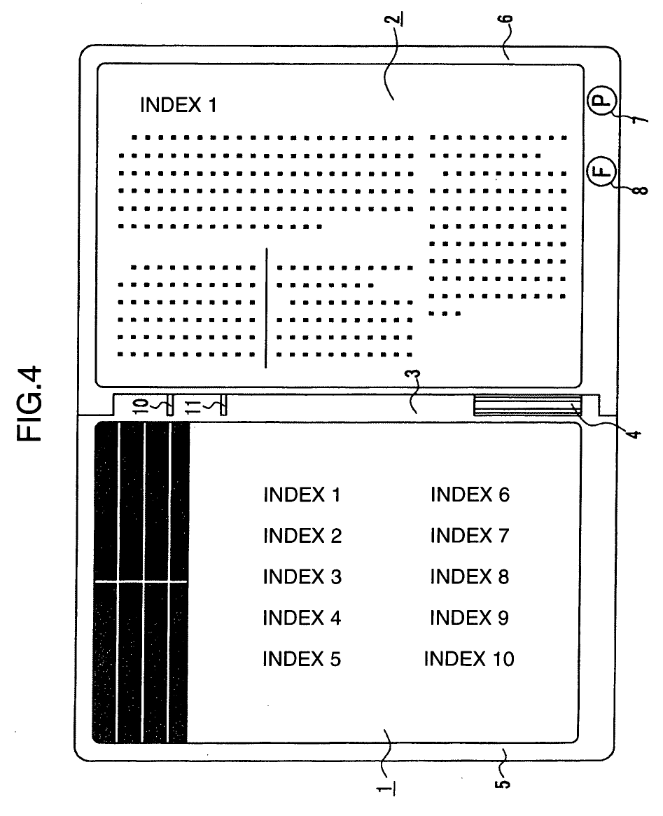

FIG. 4 shows a further display exemplification. In this display exemplification, a content which has been transmitted via a communication unit (not shown) from a network is displayed on the main displays 1 and 2, in this exemplification, an electronic newspaper is displayed thereon. Indexes are displayed on the main display 1 in the resolution of 200 ppi, and then, since an index is selected and this selected index is clicked by using, for instance, an input pen (will be explained later), a text of the electronic newspaper can be obtained. This text is displayed on the main display 2 in a black/white mode and in the resolution of 600 ppi.

### Display Principle of Display Device

In this case, the display device used in the portable information processing apparatus according to the embodiment mode of the present invention will now be briefly explained. In this case, a sheet display is used as the display device, while the sheet display employs such an electrophoretic technique that charged particles are moved in dispersion media by an electric field.

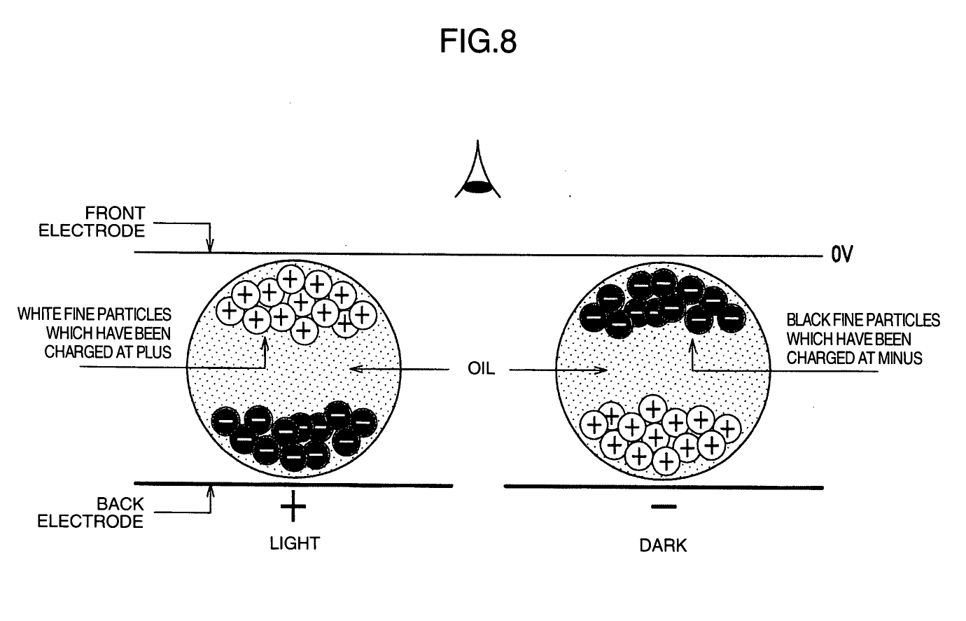

In FIG. 8, there is shown a basic structure of this sheet display. That is to say, an assumption is now made of such a condition that flexible transparent capsules are arranged in a close packing manner, and then are sandwiched by a thin transparent film and a panel board. While inner portions of these capsules arranged in this manner are filled with smoothing oil, a large amount of black/white fine particles are contained in the smoothing oil. In this embodiment mode, while a voltage of an electrode provided on the side of the transparent film is kept constant (for example, 0 V), a voltage of an electrode provided on the side of the panel board, which is located opposite to the above-described electrode, is varied between a plus voltage and a minus voltage, so that the fine particles are moved. For example, in such a case that the black particles are negatively charged and the white particles are positively charged, when a switch is turned ON, a current will flow through a panel, and a plus voltage is produced at a certain place, whereas a minus voltage is produced at another place. At the next instant time, the black particles and the white particles contained in the capsules are attracted to the surface of the transparent film in such a manner that these black and white particles move in the oil. The black particles stick to the place of the plus voltage, and the white particles stick to the place of the minus voltage. Such a condition (i.e., eye mark shown in this drawing) that this state is viewed from the front side of the transparent film corresponds to both a character and a margin thereof, which are indicated on the sheet display.

On the other hand, even when the power source is turned OFF, the character is not vanished for a some moment due to an effect of static electricity. Only when the character is rewritten, a voltage is required to be applied. As a result, the fine particles are stripped at once, and the stripped fine particles are moved in such a manner that these fine particles again move within the oil, and thereafter, stick to another place. This operation is called as the electrophoresis.

The panel board is referred to as an “active matrix”, and is designed in such a way that voltages are applied to the panel board in the unit of a pixel and in a precise manner. The active matrix is basically constituted by TFTs (Thin-Film Transistors), or the like, which is similar to a liquid crystal display, or the like. Since this active matrix is made of the reflection type element which is different from a transparent type display through which light may be penetrated, there is such a merit that a back light is not required. Also, since driving electric power is required only when a rewriting operation is carried out, a battery capacity may be decreased. As a consequence, the portable information processing apparatus can be made thinner and in a lighter weight. Also, since color filters are overlapped with each other, a color panel board may be realized.

### Second Embodiment Mode

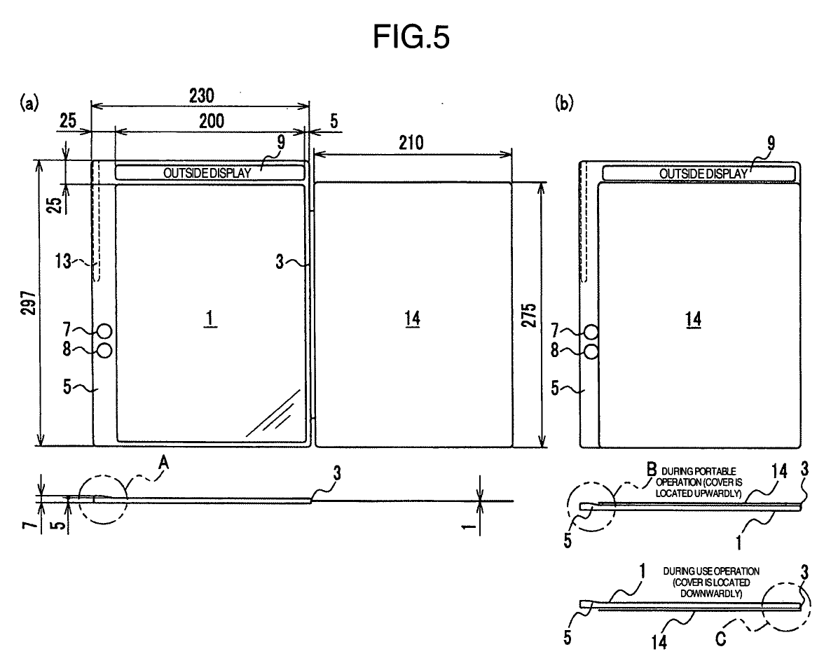

FIG. 5 is a diagram for indicating a portable information processing apparatus according to a second embodiment mode of the present invention. In FIG. 5, a front view and a sectional view of the portable information processing apparatus are indicated when the portable information processing apparatus are opened and closed, respectively.

A difference between the second embodiment mode and the first embodiment mode shown in FIG. 1 is such that only a display device of the main display 1 is mounted, while display devices are not mounted on both surfaces of a frame, and a size of this display device is different from that of the first embodiment mode. In this case, the display device of the A4-sized main display 1 is mounted on the frame, and the other frame constitutes a cover 14 which covers the main display 1 so as to protect this main display 1 when the portable information apparatus is carried. For instance, the size of the frame 5 on which the display device is mounted is designed by 297 mm×230 mm×5 mm (without cover). In the case that the portable information processing apparatus is equipped with the cover 14, a thickness of the frame 5 becomes 6 mm.

In accordance with the portable information processing apparatus shown in FIG. 5, a frame 5 on which a display device is mounted is pivotally supported by a hinge portion 3 with respect to the cover 14. The display device owns a main display 1 which performs a printing type quality high-resolution imaging operation. The hinge portion 3 is constituted by a hinge mechanism. While the hinge portion 3 is set to a fulcrum and the main display 1 is brought into a two-page spread condition, the portable information processing apparatus is used (see FIG. 5(a)). While the hinge portion 3 is set to the fulcrum, and the main display 1 is overlapped with the cover 14 so as to be folded into two displays and are stored so as to be closed, the portable information processing apparatus can be carried under such a condition that the frame 5 is protected (see FIG. 5(b)).

Also, a size of the frame 5 on which the main display is mounted is defined as 297 mm along the longitudinal direction, whereas a size of the cover 14 is defined as 275 mm along the longitudinal direction. An outside display 9 is stored into a frame portion of the main display 1 which is equivalent to a difference between these sizes, and can be visually recognized from an external area. It should also be noted that instead of the outside display 9, the solar cell 12 shown in FIG. 3 may be mounted.

As a result, even under such a condition that the cover 14 is closed, a content displayed on the outside display 9 can be confirmed, and also, a recharging operation by employing the solar cell 12 can be carried out.

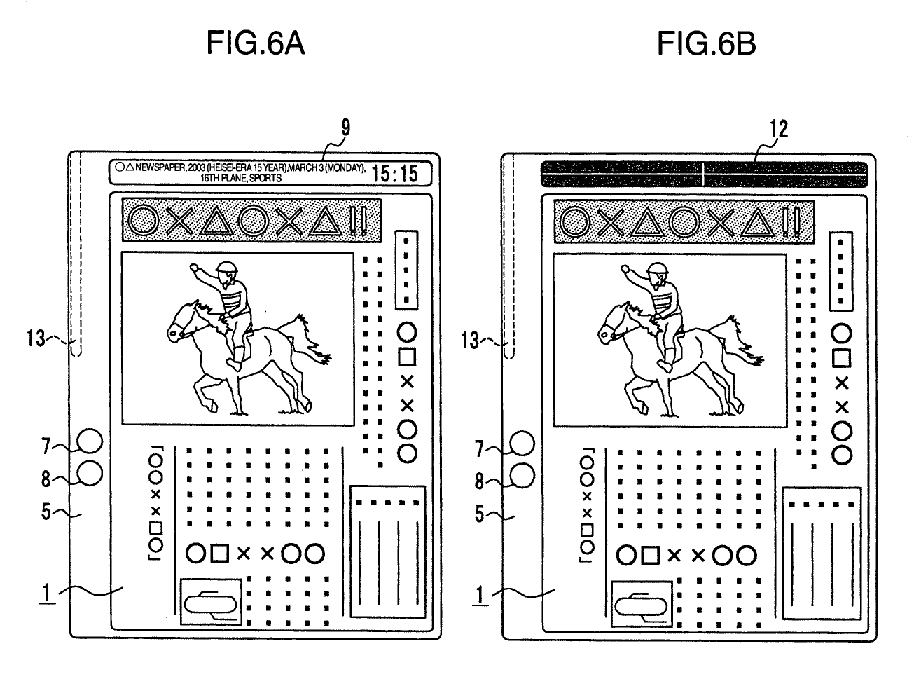

Respective mounting examples are indicated in FIG. 6A and FIG. 6B. FIG. 6A shows an example in which the outside display 9 is mounted, and FIG. 6B represents another example in which the solar cell 12 is mounted. In this case, for example, a newspaper which is acquired via a wireless LAN (Local Area Network). Indexes of this newspaper and the present time instant are displayed on the outside display 9 shown in FIG. 6A, and can be visually recognized from the external area. As a consequence, even under such a condition that the cover 14 is closed, since the outside display 9 is viewed, an outline of a content and other information can be grasped which are presently displayed on the main display 1. Also, since the solar cell 12 shown in FIG. 6B are exposed to the external area even under such a condition that the cover 14 is closed, sunlight may be captured so as to recharge this solar cell 12, and thus, the polymer battery of the main power source may be supported as an auxiliary power source.

It is conceivable that as the contents displayed on the main display 1, catalogs and the like may be employed which are distributed in exhibitions. In this alternative case, for instance, when a user passes through a gate of an entrance of an exhibition hall, data as to catalogs and the like of exhibited products are downloaded to a portable information processing apparatus held by this user by way of a short-distance wireless communication, so that the user may view the data as to the catalogs and the like, if required.

Similar to the portable information processing apparatus shown in FIG. 1, this portable information processing apparatus may be alternatively equipped with the page-turning-over function by the rotation portion, and in addition to this function, may alternatively own a user interface capable of enlarging/compressing a displayed content, capable of storing contents, and capable of selecting a content. Also, in order to improve retrieving speeds, after a list structure has been edited by operating a personal computer, or the like, this edited list structure may be alternatively transferred to this portable information processing apparatus so as to make up a sort of contents, directory structure, a favorite and a history function.

Referring back to FIG. 5, an empty space having a size of on the order of 25 mm is present on a left edge plane of the frame 5 where the display device of the main display 1 is mounted. In this empty space, a storage space for the input pen 13 may be secured which is required so as to operate a content displayed on the main display 1. Also, such switch and the like as a power switch 7 and a function switch 8 are mounted on the frame 5.

The input pen 13 is mounted at such a position that the input pen 13 can be easily picked up and can be readily stored in correspondence with a dominant hand. Also, the switch and the like are mounted at a position where these switch and the like can be readily manipulated when the portable information processing apparatus is held. In this case, the left edge plane of the frame 5 may also be utilized as a hand held position, and a slope is made in this left edge plane in such a manner that this slope is directed toward the main display 1 in order that this portable information processing apparatus may be readily held and carried (namely, circular frame “A” of FIG. 5). Also, the cover 14 is rotated at an angle of 360 degrees while the hinge portion 3 is located as an axis in such a manner that the surface of the frame becomes flat when the cover 14 is closed in order to carry the portable information processing apparatus (circular frame “B” of FIG. 5), and also in such a manner that this frame surface is flat-fitted to a rear plane of the frame 5 where the display device of the main display 1 is mounted (circular frame “C” of FIG. 5).

It should be noted that the arrangement designed for the right-handed person has been indicated in this drawing. In the case of the arrangement designed for the left-handed person, the position is turned over with respect to the right/left direction.

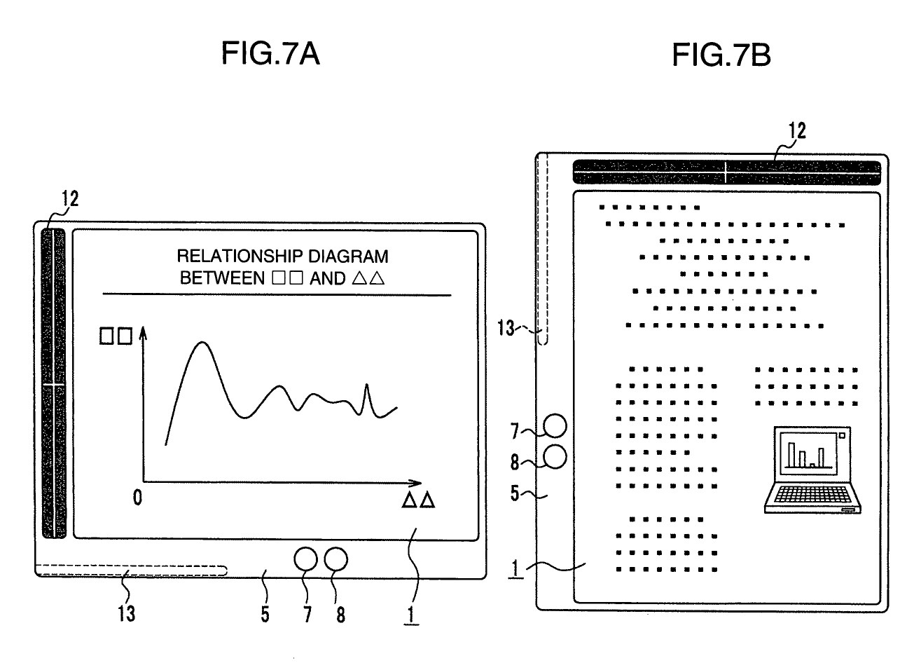

FIG. 7 indicates display exemplifications as document viewers. That is, FIG. 7A shows a longer side-ways type of a display exemplification which is used to display a document, or the like, which have been formed based upon PowerPoint (registered trademark). FIG. 7B shows a shorter-side-at-top type of a display exemplification which is used to display a PDF (Portable Document Format) document, or the like.

In the former display exemplification, the input pen 13, and the switch and the like are mounted on a frame under a screen. Also, the solar cell 12 is mounted on a frame located at a left side of the screen. In the latter display exemplification, the input pen 13, and the switch and the like are mounted on a frame located at a left side of a screen. Also, the solar cell 12 is mounted on a frame above the screen. In other words, although FIG. 7A and FIG. 7B show the diagrams of the same portable information processing apparatus, the former diagram indicates such a condition that the longer-side-ways type document is displayed, whereas the latter diagram represents such a condition that the shorter-side-at-top type document is displayed. It is so assumed that the same image data may be displayed under both the longer-side-ways condition and the shorter-side-at-top condition. Also, these display conditions may be switched.

Now, a supplementary explanation as to an input apparatus will be made. In the above-described embodiment modes, the rotation portion 4, the switch and the like, and the input pen 13 have been exemplified as the input apparatus. It is so conceivable that a touch panel, a roller, a tablet, and the like may be additionally provided, if necessary. In other words, the input operations may be supported by that a URL is inputted by the touch panel, a content is moved to front/rear screens by the roller, a content is moved between windows by the roller, and a pointing operation is performed by the tablet. It should also be noted that the rotation portion 4 may be used so as to sequentially select links other than a page-turning-over function of an electronic book.

### Internal Structure and Operations of Portable Information Processing Apparatus

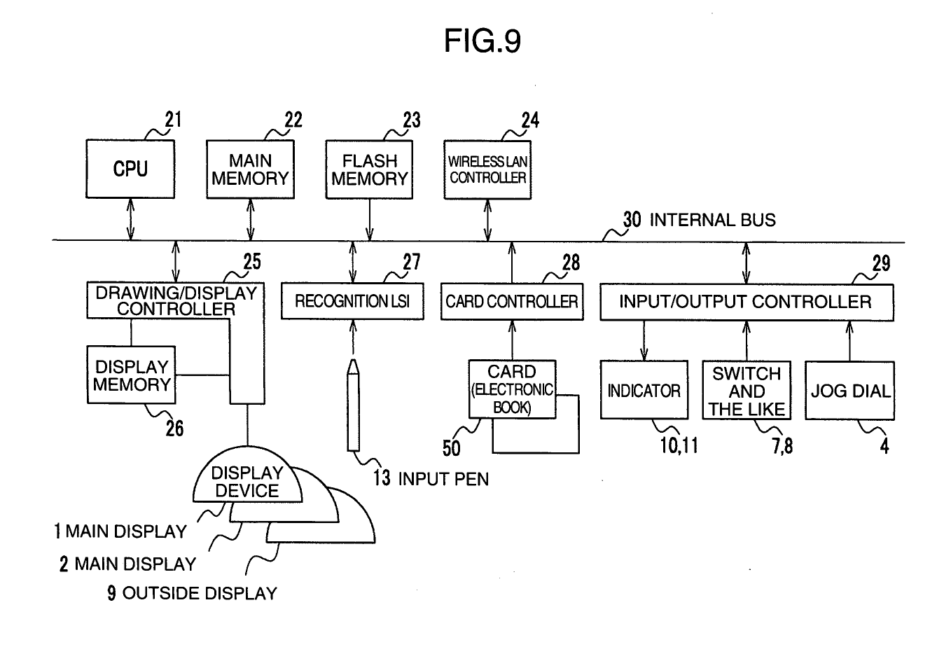

FIG. 9 is a block diagram for indicating an internal structure of a portable information processing apparatus according to an embodiment mode of the present invention. The portable information processing apparatus of the present invention is arranged by a CPU 21, a main memory 22, a flash memory 23, a wireless LAN controller 24, a drawing/display controller 25, a display memory 26, a recognition LSI 27, a card controller 28, and an input/output (I/O) controller 29. These structural elements are connected to each other via an internal bus 30 which is constituted by a plurality of lines used for handling addresses, data, and controls.

It should be noted that the main power source is constructed of a polymer battery, and the solar cell is employed as the auxiliary power source (not shown). It should be understood that blocks to which the same reference numerals shown in FIG. 1 and FIG. 7B have been applied indicate such blocks identical to those shown in FIG. 9.

First, in order to display an electronic book on the portable information processing apparatus, a user inserts a card 50 into the card controller 28, while the electronic book has been stored in this card 50. The CPU 21 acquires this electronic book via the card controller 28 and the internal bus 30 based upon a program stored in the main memory 22, and then stores the acquired electronic book into a work space of the main memory 22.

Next, the drawing/display controller 25 reads out the electronic book from the main memory 22 to expand this read electronic book to the display memory 26 under control of the CPU 21. The drawing/display controller 25 furthermore reads out the electronic book expanded to the display memory 26 in accordance with display timing of the display device, and then displays the read electronic book on the main displays 1 and 2.

In this embodiment mode, for the sake of simple explanations, it is so assumed that the display memory 26 owns 2 pages of screen capacities, and each page thereof corresponds to the screens of the main displays 1 and 2, respectively.

The portable information processing apparatus of this embodiment mode is arranged by that both the main memory and the display memory are separately provided. These structural elements owns such a factor that the sheet display becomes bulky. As one of means for avoiding this factor, a unified memory in which a main memory and a display memory have been unified may be provided. This unified memory may achieve such an effect that the portable information processing apparatus can be made compact and slim. In other words, both the program and the display data which are processed by the CPU are stored into a single memory. In the case that such a unified memory is employed, such an event may probably occur in which accesses to this unified memory compete with each other, and thus any one of these accesses occupies a bus. However, this event may be solved by employing a bus arbitration function.

When a page-turning-over operation instruction is issued by operating the rotation portion 4 by the user, the CPU 21 acquires this instruction via the input/output controller 29 and the internal bus 30. Then, the CPU 21 reads out a content of a page which is newly displayed from the main memory 22, and updates a content of the display memory 26 via the drawing/display controller 25, and then supplies this updated content to the main displays 1 and 2. As a consequence, the page obtained after “page-turning-over” operation is displayed on the main displays 1 and 2.

A correspondence relationship between rotation amounts of the rotation portion 4 and page numbers has been previously defined in such a manner that such a page which is newly displayed may be specified, while the page which is presently displayed on the main displays 1 and 2 is employed as a reference page, based upon a rotation direction and an amount of rotation under such a condition that the rotation portion 4 is rotated along the lateral direction, so that the amount of rotation is measured. Also, for instance, since a rotation resistance is applied to the rotation portion 6, reality of such a page-turning-over operation may be alternatively given to the portable information processing apparatus. Since speakers are additionally provided with the frames 5 and 6, such a reality may be alternatively given in such a manner that when the user turns over a page, sound effects are produced. Furthermore, as the page-turning-over function, other than the rotation portion constructed of the jogdial(R) which is rotated along the right/left directions so as to turn over pages, another rotation portion may be alternatively employed in which a mouse pad is employed, and a finger of a user is moved on this mouse pad along the right/left directions so as to turn over pages.

It should also be noted that as to an instruction issued by operating the switch and the like by the user, this instruction is also acquired by the CPU 21 via the input/output controller 29 and the internal bus 30, and thus, a program which has been previously defined with respect to each of the switch and the like may be executed.

Also, as to the indicator display, for example, the CPU 21 may produce such a command for turning ON the access indicator 11 based upon a result of processing operation executed in accordance with a program stored in the main memory 22, and then the CPU 21 may output this produced command via the internal bus 30 and the input/output controller 29 to the access indicator 11, so that the access indicator 11 may be alternatively turned ON.

On the other hand, in order to display a Web screen on the portable information processing apparatus, since the user depresses the function switch 8, the user instructs a Web access. As a result, the wireless LAN controller 24 executes a site access operation under control of the CPU 21, and acquires a necessary content from this accessed site, and then stores the acquired content into either the main memory 22 or the flash memory 23.

The CPU 21 reads out this stored content from either the main memory 22 or the flash memory 23, and produces the read content as a Web screen, and then initiates the drawing/display controller 25. The drawing/display controller 25 reads out information as to the Web screen from the main memory 22, and then expands this read Web screen information to the display memory 26. Further, the drawing/display controller 25 reads out the Web screen information expanded to the display memory 26 in accordance with the display timing of the display device, and then supplies the read Web screen information to the main displays 1 and 2 so as to display thereon this supplied Web screen information.

It is so assumed that since the function switch 8 is depressed, an access menu list is displayed in the unit of a site, and thus, the user selects such a site which should be accessed from this access menu list. Also, in the screen display exemplification shown in FIG. 3, such a condition that the different contents are displayed in the different resolution for each other is represented. This screen display exemplification may be realized by the following methods. That is, the drawing/display controllers 25 corresponding to the different resolution are separately employed. Alternatively, while such a controller capable of drawing and displaying a screen in high resolution is employed, when such a screen which is displayed in low resolution is produced, such a process operation for internally lowering the high resolution is carried out within this controller.

Next, operations executed in such a case that an operation instruction is issued by using the input pen 13 will now be explained, while a screen shown in FIG. 4 is exemplified (properly refer to FIG. 9). An electronic newspaper is displayed on a left-sided screen (namely, main display 2) of the portable information processing apparatus of FIG. 4. While indexes are being displayed on one screen (main display 1) of the portable information processing apparatus, the user selects such an index whose detailed content is wanted to be read from the indexes. Then, since the user points out this index by way of the input pen 13, a text of this selected index can be displayed on the other screen (namely, main display 2).

In other words, a coordinate value pointed by the input pen 13 is calculated by the recognition LSI 27 so as to be recognized, and then, the recognized coordinate value is notified to the CPU 21. The CPU 21 checks a correspondence relationship between this recognized coordinate value and a display content, and acquires a text corresponding to the selected index from either the flash memory 23 or an external source via the wireless LAN controller 24, and then displays the acquired text on the main display 2.

### Other Embodiment Modes

While the present invention has been described with respect to the preferred embodiment modes, the present invention is not limited only to the above-described embodiment modes, but may be properly modified without departing from the gist of the present invention. For instance, while such places indicative of sizes (lengths, thickness, and the like) are made in drawings, the present invention is not limited only to these indicated sizes. Other sizes may be employed.

In FIG. 2 and FIG. 6A, the outside displays 9 are indicated, and such data as the titles, the pages, and the time are displayed on the outside displays 9. Alternatively, these contents may be previously stored in an electronic book, or may be produced by the CPU 21 time to time. In this alternative case, it is so assumed that a display memory area used for the outside display 9 has been allocated in the main memory 22, the display content of the outside display 9 is written in this display memory region, and furthermore, this display content is read therefrom so as to be supplied to the outside display 9.

As to the content displayed on the main displays 1 and 2, the following explanation has been made. That is, while the independent display memory 26 is prepared, the display content is written into the display memory 26 by the drawing/display controller 25, and further, this written display content is read so as to be displayed. Alternatively, similar to the outside display 9, while the display memory area is allocated to a partial memory area of the main memory 22, the CPU 11 may write thereinto the display content, and further, may read out this written display content so as to supply the read display content to the main displays 1 and 2. In this alternative case, although the workload of the CPU 1 is increased, this modified structure is preferable in view of both a restriction made in mounting aspects in order to make a portable information processing apparatus slim and short in light weight, and also a power saving aspect.

Also, in accordance with the above-described embodiment modes, the sheet display capable of performing the high resolution display by using the electrophoretic technique has been indicated as the display device. However, the present invention is not limited only to this sheet display, but may replace this sheet display by such a liquid crystal display, or an organic EL (Electroluminescence), if such a display device is realized. That is, this display device can have such a resolution higher than, or equal to 200 ppi in a color display; and such a resolution higher than, or equal to 300 ppi in a black/white display; and preferably such a resolution higher than, or equal to 600 ppi in the black/white display, and can have a thickness of on the order of 3 mm, which involves a frame.

### As to Printing Types Quality High-resolution Imaging Operation

In this case, a definition is made as to a “printing type quality high-resolution imaging operation”, and also, grounds of resolution thereof will now be explained.

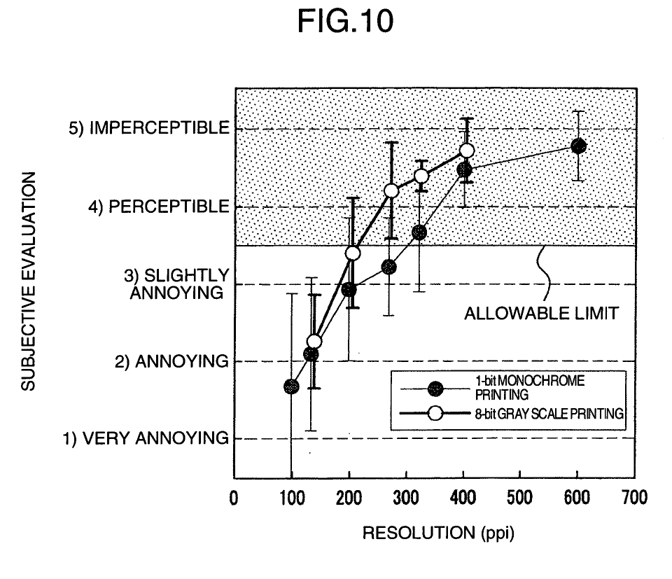

First of all, FIG. 10 shows a subjective evaluation result which has been carried out in order to clarify the resolution for a purpose of such a printing type quality high-resolution imaging operation. In this experiment, while a paperback book was simulated, Japanese sentences made by mixing Kanji characters with Katakana characters, the character sizes of which were approximately 3.5 mm, were printed out in various sorts of resolution, and then, printed matters were evaluated. In FIG. 10, both “8-bit gray scale printing” and “1-bit monochrome printing” were described in parallel to each other. This “8-bit gray scale printing” operation simulates such a display using a so-called “antialiasing” process in which a half tone is utilized in a display capable of displaying a gray scale so as to smoothly display characters in view of a visual aspect. The “1-bit monochrome printing” operation simulates an image display having no gray scale.

Examinees of the subjective evaluation are 10 persons (8 males and 2 females), and all of these persons are researchers belonging to image device researches. As an experimental method, a double-stimulus impairment scale method is employed, by which while a reference image is employed as a reference, impairment scales are given to test images, and thus, degrees of image qualities are evaluated. This image quality evaluation was carried out based upon 5 stages as to qualities of test images, namely, “Very annoying”; “Annoying”; “Slightly annoying”; “Perceptible”; and also, “Imperceptible.”

Acceptable resolution is selected to be 200 ppi in “8-bit gray scale printing” operation, and also, 300 ppi in “1-bit monochrome printing” operation. This acceptable resolution is required for the character printing type quality, and corresponds to an intermediate evaluation value between “Perceptible” and “Slightly annoying.” In such a resolution higher than, or equal to the above-described acceptable resolution, the printing type quality high-resolution imaging operation may be realized. In this case, when an image having no gray scale is displayed, a so-called “storage characteristic” capable of holding an image may be easily applied. A so-called “storage characteristic” in a display may be given to an electrophoretic display device, a liquid crystal display device, and the like, otherwise, may be applied to each of pixel circuits by a capacitance, a switch, and the like.

Next, a description is made of such a resolution capable of clearly displaying a character.

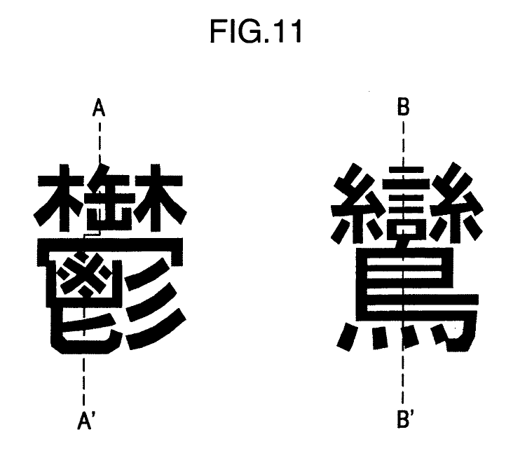

In such a case that a difficult Kanji character having a large number of strokes is displayed in low resolution, the characters thereof are simplified to be displayed. Thus, there is such a problem that human forgets the correct Kanji characters. To solve this problem, a high resolution image display capable of displaying not-simplified Kanji characters is necessarily required. As characters having a large number of strokes, for instance, there are such characters listed in the second standardized Kanji characters of the JIS Kanji code. Concretely speaking, as represented in FIG. 11, both a total number of lateral lines and a total number of inclined lines in a cutting line A-to-A′ of Kanji character of “UTSU”, and in another cutting line B-to-B′ of Kanji character of “RAN” are equal to 11 lines and 13 lines, respectively. In order to display these Kanji characters without any simplification, such a pixel number larger than the total line numbers by 2 times+1 is required. In the case that this is displayed in such a character size of on the order of 3.5 mm which is continuously employed in paperback books, a pixel pitch smaller than, or equal to 130 μm is required and such a resolution higher than, or equal to approximately 200 ppi is required. Furthermore, as apparent from FIG. 11, in the character display, it is preferable that a width of a white portion becomes wider than a width of a black line. As a result, assuming now that the white portion is made larger than the line number by two times, a total number of such pixels which are required so as to display the characters becomes larger than, or equal to the total line number by 3 times +1. In the case that this is displayed in such a character size of on the order of 3.5 mm which is continuously employed in paperback books, a pixel size smaller than, or equal to 84.7 μm is required and such a resolution higher than, or equal to approximately 300 ppi is required.

In other words, since the display surface of the display device is designed in such a manner that the pixel size is smaller than, or equal to 84.7 μm, or the resolution is higher than, or equal to 300 ppi, even in such a case that a Japanese sentence contains such Kanji characters having large numbers of strokes which are listed in the second standardized Kanji characters, all of these Kanji characters can be displayed without any simplification.

While the above-explained descriptions have been made as to the embodiments, the present invention is not limited only thereto. However, the present invention may be modified, changed, and substituted within the spirit of the present invention and the accompanying claims thereof, as apparent to those skilled in the art.

1. A portable information processing apparatus comprising:
two display devices;
two frames which mount thereon said two display devices respectively; and
hinges for coupling said frames with each other; wherein:
in the case that each of said display devices performs a monochrome display, each of said display devices owns a display surface for displaying an image whose pixel size is smaller than, or equal to 127 μm;
said two frames are pivotally supported by said hinges in an openable/closable manner; and
when said two frames are closed, two display portions are brought into such a condition that said two display portions are overlapped with each other and are folded into two displays while said hinges are set to a fulcrum, whereas when said two frames are opened, said two display portions are brought into a two-page spreading condition, while said hinges are set to the fulcrum.

2. A portable information processing apparatus comprising:
two display devices;
two frames which mount thereon said two display devices respectively; and
hinges for coupling said frames with each other; wherein:
in the case that each of said display devices performs a gray scale display, each of said display devices owns a display surface for displaying an image whose pixel size is smaller than, or equal to 84.7 μm;
said two frames are pivotally supported by said hinges in an openable/closable manner; and
when said two frames are closed, two display portions are brought into such a condition that said two display portions are overlapped with each other and are folded into two displays while said hinges are set to a fulcrum, whereas when said two frames are opened, said two display portions are brought into a two-page spreading condition, while said hinges are set to the fulcrum.

3. A portable information processing apparatus comprising:
two display devices;
two frames which mount thereon said two display devices respectively; and
hinges for coupling said frames with each other; wherein:
each of said display devices owns a display surface for displaying an image whose pixel size is smaller than, or equal to 42.3 μm;
said two frames are pivotally supported by said hinges in an openable/closable manner; and
when said two frames are closed, two display portions are brought into such a condition that said two display portions are overlapped with each other and are folded into two displays while said hinges are set to a fulcrum, whereas when said two frames are opened, said two display portions are brought into a two-page spreading condition, while said hinges are set to the fulcrum.

4. A portable information processing apparatus as claimed in claim 1 wherein:
in the case that an electronic book is displayed on said display surface, said hinges own a page-turning-over function by which pages of said electronic book are turned over.

5. A portable information processing apparatus as claimed in claim 1 wherein:
said information processing apparatus is comprised of a rotation portion which is laterally rotated along a longitudinal direction and at a lower portion of said hinges.

6. A portable information processing apparatus comprising:
two display devices;
two frames which mount thereon said two display devices respectively; and
hinges for coupling said frames with each other; wherein:
each of said display devices owns a display surface;
said hinges own rotation portions which are laterally rotated along a longitudinal direction and at a lower portion of said hinges;
said two frames are pivotally supported by said hinges in an openable/closable manner; and
when said two frames are closed, two display portions are brought into such a condition that said two display portions are overlapped with each other and are folded into two displays while said hinges are set to a fulcrum, whereas when said two frames are opened, said two display portions are brought into a two-page spreading condition, while said hinges are set to the fulcrum.

7. A portable information processing apparatus as claimed in claim 5 wherein:
said rotation portions correspond to such shorter-side-at-top rotation portions which are laterally rotated along the longitudinal direction and at center lower portions of said hinges; and
an image which is displayed on said display surface is changed by rotating said rotation portions.

8. A portable information processing apparatus as claimed in claim 5, or claim 6 wherein:
a switch required so as to operate said portable information processing apparatus is owned at one edge portion of any one of said two frames.

9. A portable information processing apparatus as claimed in claim 8 wherein:
under such a condition that said two display surfaces are overlapped with each other and are fold to two displays so as to be stored, said portable information processing apparatus has an outside display at such a position of the other frame on which said switch is not mounted, said position being overlapped with the frame on which said switch is mounted.

10. A portable information processing apparatus as claimed in claim 1 wherein:
said hinges own an indicator for displaying a condition of a power supply; and
said indicator can be visually recognized from an external area even under such a condition that said two display surfaces have been overlapped with each other and have been fold to two displays so as to be stored.

11. A portable information processing apparatus comprising:
two display devices;
two frames which mount thereon said two display devices respectively; and
hinges for coupling said frames with each other; wherein:
said two display devices own a first display surface for executing an image display operation of predetermined resolution, and a second display surface for executing a character display operation in higher resolution than that of said first display surface;
said two frames are pivotally supported by said hinges in an openable/closable manner; and
when said two frames are closed, said first and second display surfaces are brought into such a condition that said first and second display surfaces are overlapped with each other and are folded into two displays while said hinges are set to a fulcrum, whereas when said two frames are opened, said first and second display surfaces are brought into a two-page spreading condition, while said hinges are set to the fulcrum.

12. A portable information processing apparatus as claimed in claim 11 wherein:
a portion of the frame on which said display device having said first display surface is mounted owns a solar cell.

13. A portable information processing apparatus comprising:
a frame on which a display device having a display surface is mounted;
a cover for protecting the display surface of said display device; and
a hinge for coupling said frame to said cover; wherein:
said display device owns a display surface capable of displaying thereon an image in a pixel size smaller than, or equal to 84.7 μm;
said frame and said cover are pivotally supported by said hinge in an openable/closable manner; and
when said cover protects said frame, said cover is rotated while said hinge is set to a fulcrum so as to cover said display surface within said frame; whereas when the display surface within said frame is visually confirmed, said cover is rotated while said hinge is set to the fulcrum so as to expose said display surface.

14. A portable information processing apparatus as claimed in claim 13 wherein:
said portable information processing apparatus comprises:
a receiver capable of receiving information which is displayed on said display surface in a wireless communication manner;
a holder for storing thereinto a pen which is used to operate the information displayed on said display surface; and
a switch used to operate the information displayed on said display surface.

15. A portable information processing apparatus as claimed in claim 13 wherein:
said portable information processing apparatus comprises a means capable of changing the image displayed on said display surface into either a longer-side-ways image or a shorter-side-at-top image.

16. A portable information processing apparatus as claimed in claim 13 wherein:
a length of said frame along the longitudinal direction is made longer than a length of said cover along the longitudinal direction.

17. A portable information processing apparatus as claimed in claim 16 wherein:
a portion of said frame which is not covered by said cover under such a condition that said cover and said frame are closed owns an outside display.

18. A portable information processing apparatus as claimed in claim 16 wherein:
a portion of said frame which is not covered by said cover under such a condition that said cover and said frame are closed owns a solar cell.

19. An image displaying method in the portable information processing apparatus recited in claim 5, wherein:
a page-turning-over operation of an electronic book is carried out by that said electronic book is displayed on said two display surfaces under two-page spreading condition, and said rotation portion is operated.

20. An image displaying method in the portable information processing apparatus recited in claim 9, wherein:
a page-turning-over operation of an electronic book is carried out by that said electronic book is displayed on said two display surfaces under two-page spreading condition, and said rotation portion is operated; and bibliographic information containing a page position of the electronic book which is displayed on said display surfaces is displayed on said outside display in correspondence with said page-turning-over operation.

21. An image displaying method in the portable information apparatus recited in claim 11, wherein:
a Web screen is displayed on said first display surface, and the electronic book is displayed on said second display surface.

22. An image displaying method in the portable information apparatus recited in claim 17, wherein:
information for indicating a content of an image which is displayed on said display surface is displayed on said outside display.
